(19) United States
(12) Patent Application Publication
(10) Pub. No.: US 2026/0360832 A1
(43) Pub. Date: Nov. 12, 2026

(54) ELECTROMOBILITY COMPONENTS

(71) Applicant: LANXESS Deutschland GmbH, Cologne (DE)

(72) Inventors: Marvin Kischkewitz, Duesseldorf (DE); Lars May, Langenfeld (DE)

(73) Assignee: LANXESS Deutschland GmbH, Cologne (DE)

(21) Appl. No.: 19/515,028

(22) PCT Filed: Aug. 1, 2024
(86) PCT No.: PCT/EP2024/071802

§ 371 Date: Feb. 27, 2026

(30) Foreign Application Priority Data
Sep. 5, 2023 (EP) 23195337.3

(51) Int. Cl. H01M 10/42; H01M 8/02

(52) U.S. Cl. CPC H01M 10/42; H01M 8/02

(57) ABSTRACT

The present invention relates to tracking-resistant electromobility components having a colour distance ΔE from the L*a*b* coordinates to a colour number of the RAL colour chart beginning with a “2” of <20 containing polymer compositions based on at least one polyamide and 1,3-dihydro-5,6-bis(((2-hydroxy-1-naphthyl)methylene)amino-2H-benzimidazol-2-onato(2-)-N5,N6,O5,O6)nickel and to the use of 1,3-dihydro-5,6-bis(((2-hydroxy-1-naphthyl)methylene)amino-2H-benzimidazol-2-onato(2-)-N5,N6,O5,O6)nickel for producing polyamide-based tracking-resistant electromobility components having a colour distance ΔE from the L*a*b* coordinates to a colour number of the RAL colour chart beginning with a “2” of <20.

The present invention relates to tracking-resistant electromobility components having a colour distance ΔE from the L*a*b* coordinates to a colour number of the RAL colour chart beginning with a “2” of <20 containing polymer compositions based on at least one polyamide and 1,3-dihydro-5,6-bis(((2-hydroxy-1-naphthyl)methylene)amino-2H-benzimidazol-2-onato(2-)-N5,N6,O5,O6)nickel and to the use of 1,3-dihydro-5,6-bis(((2-hydroxy-1-naphthyl)methylene)amino-2H-benzimidazol-2-onato(2-)-N5,N6,O5,O6)nickel for producing polyamide-based tracking-resistant electromobility components having a colour distance ΔE from the L*a*b* coordinates to a colour number of the RAL colour chart beginning with a “2” of <20.

### PRIOR ART

Technical thermoplastics such as polyamides are important materials, especially also in the field of components for motor vehicles, due to their good mechanical stability, their chemicals resistance, very good electrical properties and good workability. They have therefore also formed an important constituent for manufacturing demanding motor vehicle components for many years. While the internal combustion engine has been the dominant drive concept for many years, new demands with regard to choice of materials are also arising in the course of the search for alternative drive concepts. A significant role is played here by electromobility, where the internal combustion engine has been replaced partly (hybrid vehicle [HEV, PHEV, BEV Rex]) or completely (electromobile [BEV, FCEV]) by one or more electric motors which typically draw their electrical energy from batteries or fuel cells. While conventional vehicles having an internal combustion engine (ICE) as their sole means of propulsion typically make do with a 12 V onboard voltage system, hybrid and electric vehicles having electric motors as drive unit require significantly higher voltages. This poses a serious additional risk potential for the direct region and the immediate surroundings of such high-voltage components, which plays an increasingly important role in technical specifications or else in standards. An important role is played here by the unambiguous marking of such dangerous regions in order thus to avoid unintentional contact with people, especially a driver, mechanic etc., with unambiguous colour marking of such electromobility components in turn being particularly important. At https://avt.inl.gov/sites/default/files/pdf/hev/hevtechspecr1.pdf, the Advanced Vehicle Team of the Idaho National Laboratory for HEV (Hybrid Electric Vehicles) has published a technical specification which calls for clear colour marking with the colour orange for all apparatuses subject to a high voltage of not less than 60 V. Such components to be marked in orange for electric drive of vehicles, in particular of motor vehicles, based on battery or fuel cell technology and components and systems to be used for electric drive units are electromobility components in the context of the present invention. However, as electrical components, voltage-conducting components or components subject to electrical voltage the tracking resistance is also an essential criterion for such electromobility components.

The tracking resistance defines the insulation strength of the surface (tracking path) of insulators, in particular under the influence of moisture and contaminants. It defines the maximum tracking current that may occur under standardized test conditions (predetermined voltage, thin-layer material) in a defined test configuration (electrode distance, electrode shape). A surface may be contaminated by abrasion or dust for example. In the case of polymer-based components, ingredients can diffuse to the surface and “contaminate” said surface. At sufficiently high atmospheric humidity this can form a conductive coating, through which a so-called tracking current flows. Some materials react quite sensitively to this energy input and are gradually destroyed by the electrochemical stress. The resulting carbon-containing decomposition products, in turn, cause the path taken by the tracking current to grow, in some cases with treeing, until electrical breakdown occurs.

The CTI value (comparative tracking index) in volts is a measure of the tendency to form a conductive path, especially in the case of contamination and moisture. Typical CTI values of selected materials are phenolic resin: 125 V; polyimide, Kapton: 150 V; PE-LD, PE-HD (polyethylene): 600 V; PTFE (polytetrafluorethylene): 600 V. The CTI value is standardized only for voltages up to 600 V. For higher voltages it is also possible to test high-voltage tracking resistance (IPT or inclined plane tracking value). The CTI value indicates the voltage up to which the material surface is nonconductive. The standard EN50124 establishes a relationship between insulator groups and the CTI value: Insulator group I=CTI>600V; Insulation group II=400V<CTI<600V; Insulation group IIIa=175V<CTI<400V; Insulation group IIIb=100V<CTI<175 V.

The CTI value to be determined for the tracking resistance in the context of the present invention defines the voltage up to which the base material shows no tracking when 50 droplets of standardized electrolyte solutions (A or B, accordingly KA or KB value) are applied dropwise. Measurement is carried out at the surface, a droplet falling between two platinum electrodes every 30 seconds. The failure criterion is a tracking current of >0.5 A. Details of the method of measurement of the CTI value are specified in IEC 60112.

Electromobility components are known to the person skilled in the art from EP 3 947 020 B1, wherein these, designated (172), may include for example junction boxes, control units and/or wiring. According to the invention electromobility components include not only such components in direct contact with voltage-conducting parts but also those that directly adjacent thereto or in spatial proximity thereto act as a touch guard, a warning marking or a shielding means, wherein components in direct contact with the voltage-conducting parts are preferred according to the invention. In respect of battery components, electromobility components are, according to the invention, preferably standard and round cell modules, cell housings, cell connectors, cell contacting systems, module connectors, pressure compensating elements, seals and intelligent battery management systems. In respect of proton-exchange membrane fuel cells (PEMFC), electromobility components are preferably modules or stack modules, metallic bipolar plates, end and media modules and sealing systems. In an electric drive unit (EDU), electromobility components may be seals and other components, in particular function-integrated housing lids, housing seals, shaft sealing rings, disk carriers and stamped stacks.

However, electromobility components in the context of the present invention finally also include shielding systems and dynamic precision parts.

However, due to high processing temperatures of in some cases >300 °C, especially during compounding and during injection moulding, the choice of suitable colourants for the orange marking of electromobility components is very limited especially for technical thermoplastics such as polyamides. Thus under extreme demands, especially under the demands in electromobility, dyes have a tendency to migrate out of the plastic matrix (blooming), which at elevated temperatures results in a reduction in colour intensity, or dyes migrate into other materials, for example adjacent plastics or plastic parts, which is known as bleeding. Such a dye migrating due to mechanical or physical processes can lead to adverse functional impairments. For example, a leakage current is mentioned here, which can result from the deposition of migrated dye on the surface of electrical contacts. In electrical engineering a tracking current is to be understood as meaning an uncontrollable and undesired current which flows between two insulators along the surface of an insulator. The shortest path taken by this tracking current on the insulator surface is referred to as the tracking path. These fault currents on the insulator surface result in changes in the insulator over time. In the field of electrical components, migration of ingredients out of plastics is therefore generally unwanted since it can affect the properties of the plastics and of spatially adjacent parts, with the result that the function of the electrical component is no longer assured in some cases.

EP 3 792 302 A1 describes polyamide compositions for high-voltage components in electromobility which can correspond to the colour numbers RAL2003, RAL2004, RAL2007, RAL2008, RAL2010 or RAL2011. Polyamide 6, polyamide 66 and/or polyamide 46 are disclosed as the polyamides. Ni 2-hydroxynaphthylbenzimidazole is inter alia proposed as an additional colourant of component E to be used in combination with solvent Orange 111. EP 3 792 302 A1 had for its object retain low tracking resistance coupled with amenability to laser marking of high-voltage components

EP 3 868 817 A1 discloses polymer compositions, products producible therefrom, preferably high-voltage components, particularly preferably high voltage components for electromobility containing A) 100 parts by mass of polyamide and B) 0.01 to 5 parts by mass, particularly preferably 0.01 to 3 parts by mass, of at least one pigment system based on inorganic mixed oxides containing titanium dioxide, tin oxide and zinc oxide with the proviso of a ΔE to the L*a*b* coordinates of a colour number of the RAL colour chart beginning with a “2” of <30. EP 3 868 817 A1 had for its object to provide improved amenability to laser marking compared to the prior art and improved lightfastness as well as improved thermal stability to the effect that under UV light and under thermal stress the original colour achieved immediately after injection moulding is retained over a longer period than in the case of 12H-phthaloperin-12-one.

CN 112 940 500 B describes fuses made of polyamide that has been provided with flame retardants and colourant. Pigment Orange 68 is also recited as a colourant.

Example 5 of CN 109 762 162 A describes polymerization of caprolactam in the presence of pigment orange 68 to achieve a good distribution of the additives in the masterbatches.

However, starting from the teaching of EP 3 947 020 B1 it is an object of the present invention to provide tracking-resistant electromobility components based on polyamides which are both unambiguously marked and recognizable via the colour orange but simultaneously undergo no significant reduction in the CTI determinable according to IEC 60112 as a measure of tracking resistance as a result of this colour marking.

It has surprisingly now been found that electromobility components based on polyamides and 1,3-dihydro-5,6-bis(((2-hydroxy-1-naphthyl)methylene)amino-2H-benzimidazol-2-onato(2-)-N5,N6,O5,O6)nickel meet the requirements specified when the colour orange is defined by a colour distance ΔE from the L*a*b* coordinates to a colour number of the RAL colour chart beginning with a “2” of <20 and the use of the colourant 1,3-dihydro-5,6-bis(((2-hydroxy-1-naphthyl)methylene)amino-2H-benzimidazol-2-onato(2-)-N5,N6,O5,O6)nickel ensures that the tracking resistance exhibits a maximum divergence in the CTI of 2.5% relative to the same composition but without colourant, in particular without 1,3-dihydro-5,6-bis(((2-hydroxy-1-naphthyl)methylene)amino-2H-benzimidazol-2-onato(2-)-N5,N6,O5,O6)nickel.

### SUBJECT MATTER OF THE INVENTION

The present invention provides tracking-resistant electromobility components having a colour distance ΔE from the L*a*b* coordinates to a colour number of the RAL colour chart beginning with a “2” of <20 based on at least one polyamide and 1,3-dihydro-5,6-bis(((2-hydroxy-1-naphthyl)methylene)amino-2H-benzimidazol-2-onato(2-)-N5,N6,O5,O6)nickel having a CTI determinable according to IEC 60112 in the range from 525 to 600 volts and a maximum divergence in the CTI of 2.5% relative to a component of the same composition without colourant.

The invention preferably relates to tracking-resistant electromobility components for the process according to the invention having a colour distance ΔE from the L*a*b* coordinates to a colour number of the RAL colour chart beginning with a “2” of <10, particularly preferably <5.

Preference is given to tracking-resistant electromobility components, wherein 0.01 to 5 parts by mass, particularly preferably 0.01 to 3 parts by mass, of 1,3-dihydro-5,6-bis(((2-hydroxy-1-naphthyl)methylene)amino-2H-benzimidazol-2-onato(2-)-N5,N6,O5,O6)nickel are present per 100 parts by mass of polyamide.

The invention further relates to the use of 1,3-dihydro-5,6-bis(((2-hydroxy-1-naphthyl)methylene)amino-2H-benzimidazol-2-onato(2-)-N5,N6,O5,O6)nickel to obtain tracking-resistant polyamide-based electromobility components having a colour distance ΔE from the L*a*b* coordinates to a colour number of the RAL colour chart beginning with a “2” of <20, preferably <10, in particular <5, wherein the tracking resistance in the form of a CTI determinable according to IEC 60112 is in the range from 525 to 600 volts with a maximum divergence in the CTI of 2.5% relative to a component of the same composition without colourant. It is preferable to employ 1,3-dihydro-5,6-bis(((2-hydroxy-1-naphthyl)methylene)amino-2H-benzimidazol-2-onato(2-)-N5,N6,O5,O6)nickel in combination with titanium dioxide.

In the use according to the invention it is preferable when 0.01 to 5 parts by mass, particularly preferably 0.01 to 3 parts by mass, of 1,3-dihydro-5,6-bis(((2-hydroxy-1-naphthyl)methylene)amino-2H-benzimidazol-2-onato(2-)-N5,N6,O5,O6)nickel are present per 100 parts by mass of polyamide.

In the use according to the invention it is particularly preferable when 0.01 to 5 parts by mass, particularly preferably 0.01 to 3 parts by mass, of 1,3-dihydro-5,6-bis(((2-hydroxy-1-naphthyl)methylene)amino-2H-benzimidazol-2-onato(2-)-N5,N6,O5,O6)nickel and 1 to 150 parts by mass, particularly preferably 5 to 80 parts by mass, very particularly preferably 10 to 50 parts by mass, of titanium dioxide are present per 100 parts by mass of at least one polyamide.

Preparation of polymer compositions for producing electromobility components according to the invention is carried out by compounding and subsequent processing by injection moulding, by extrusion or by blow moulding by mixing the polyamide to be employed as starting material with 1,3-dihydro-5,6-bis(((2-hydroxy-1-naphthyl)methylene)amino-2H-benzimidazol-2-onato(2-)-N5,N6,O5,O6)nickel, preferably in the aforementioned ratio, in at least one mixing apparatus. This affords moulding materials that either consist exclusively of these two components or else also contain at least one further component in addition to these two components.

For the sake of clarity, it is noted that the scope of the present invention comprises all of the definitions and parameters recited below in general or specified in preferred ranges in any desired combinations. This likewise relates to the combination of the stated amounts for the individual components in relation to the processes and uses claimed. The standards cited in the context of this application relate to the edition current at the filing date of the present invention. Unless otherwise stated, reported percentages are percentages by weight.

Tracking-resistant electromobility components according to the invention for electromobility are coloured orange using 1,3-dihydro-5,6-bis(((2-hydroxy-1-naphthyl)methylene)amino-2H-benzimidazol-2-onato(2-)-N5,N6,O5,O6)nickel, wherein hues corresponding in the RAL colour system to the colour numbers RAL2001, RAL2003, RAL2004, RAL2007, RAL2008, RAL2009, RAL2010 and RAL2011 are particularly preferred and the hues corresponding in the RAL colour system to the colour numbers RAL2003, RAL2008, RAL2010 and RAL2011 are very particularly preferred.

“Similar hues” permissible according to the invention and comprised by the present invention are those whose colour distance in the L*a*b* system to a colour number of the RAL colour chart beginning with a “2” has a ΔE of <20, preferably <10, particularly preferably <5. For elucidation of ΔE defined in EN ISO 11664-4 see, for example: https://de.wikipedia.org/wiki/Deta_E.

### Orange

In the context of the present invention, orange is considered to mean a colour which, in the RAL colour system according to https://de.wikipedia.org/wiki/RAL-Farbe#Orange, has a colour number beginning with a “2” in the RAL colour chart. In particular, at the filing date of the present invention, a distinction is made between orange hues according to Tab.1:

TABLE 1

| | | L* | a* | b* |
|---|---|---|---|---|
| RAL 2000 | Yellow orange | 58.20 | 37.30 | 68.68 |
| RAL 2001 | Red orange | 49.41 | 39.79 | 35.29 |
| RAL 2002 | Blood orange | 47.74 | 47.87 | 33.73 |
| RAL 2003 | Pastel orange | 66.02 | 41.22 | 52.36 |
| RAL 2004 | Pure orange | 56.89 | 50.34 | 49.81 |
| RAL 2005 | Luminous orange | 72.27 | 87.78 | 82.31 |
| RAL 2007 | Luminous bright orange | 76.86 | 47.87 | 97.63 |
| RAL 2008 | Bright red orange | 60.33 | 46.91 | 60.52 |
| RAL 2009 | Traffic orange | 55.83 | 47.79 | 48.83 |
| RAL 2010 | Signal orange | 55.39 | 40.10 | 42.42 |
| RAL 2011 | Deep orange | 59.24 | 40.86 | 64.50 |
| RAL 2012 | Salmon orange | 57.75 | 40.28 | 30.66 |
| RAL 2013 | Pearl orange | 40.73 | 32.14 | 34.92 |

Tab.1 shows the apparatus-independent CIE L*a*b* colour values for the respective RAL value: L* stands for luminance, a* describes the colour locus with respect to the red-green axis and b* describes the colour locus with respect to the yellow-blue axis using D65 standard light with a 10° field of view of a standard observer. The colour model is standardized in EN ISO 11664-4 “Colorimetry—Part 4: CIE 1976 L*a*b* Colour space”. For L*a*b* colour space (also: CIELAB), see: https://de.wikipedia.org/wiki/Lab-Farbraum. Each colour in the colour space is defined by a colour locus having the Cartesian coordinates {L*, a*, b*}. The a*b* coordinate plane was constructed using opponent colour theory. Green and red are at opposite ends of the a* axis from one another and the b* axis runs from blue to yellow. Complementary hues are respectively opposite one another at a 180° angle; all achromatic colours are arranged in the middle thereof (the coordinate origin a*=0, b*=0).

The L* axis describes the brightness (luminance) of the colour with values of 0 to 100. In the diagram it stands perpendicular to the a*b* plane at the origin. It may also be referred to as the neutral grey axis since all achromatic colours (grey hues) are contained between the endpoints of black (L*=0) and white (L*=100). The a* axis describes the green or red fraction of a colour, with negative values representing green and positive values representing red. The b* axis describes the blue or yellow fraction of a colour, with negative values representing blue and positive values representing yellow. The a* values range from approximately −170 to +100 and the b* values from −100 to +150, with the maximum values being achieved only at moderate brightness of certain hues. The CIELAB colour solid has its greatest extent in the region of moderate brightness, although this differs in height and size depending on the colour range.

### FURTHER PREFERRED EMBODIMENTS OF THE INVENTION

In a preferred embodiment the intervention relates to tracking-resistant electromobility components having a colour distance ΔE from the L*a*b* coordinates to a colour number of the RAL colour chart beginning with a “2” of <20 which contain not only the at least one polyamide and 1,3-dihydro-5,6-bis(((2-hydroxy-1-naphthyl)methylene)amino-2H-benzimidazol-2-onato(2-)-N5,N6,O5,O6)nickel but also at least one filler and/or reinforcer, preferably in an amount of 1 to 150 parts by mass, particularly preferably in an amount of 5 to 80 parts by mass, very particularly preferably in an amount of 10 to 50 parts by mass, in each case based on 100 parts by mass of at least one polyamide. A filler particularly preferred according to the invention is titanium dioxide.

In a further preferred embodiment the intervention relates to tracking-resistant electromobility components having a colour distance ΔE from the L*a*b* coordinates to a colour number of the RAL colour chart beginning with a “2” of <20 which contain not only the at least one polyamide and 1,3-dihydro-5,6-bis(((2-hydroxy-1-naphthyl)methylene)amino-2H-benzimidazol-2-onato(2-)-N5,N6,O5,O6)nickel but also at least one flame retardant, preferably in an amount of 3 to 100 parts by mass, particularly preferably in an amount of 5 to 80 parts by mass, very particularly preferably in an amount of 10 to 50 parts by mass, in each case based on 100 parts by mass of at least one polyamide.

In a further preferred embodiment the intervention relates to tracking-resistant electromobility components having a colour distance ΔE from the L*a*b* coordinates to a colour number of the RAL colour chart beginning with a “2” of <20 which contain not only the at least one polyamide and 1,3-dihydro-5,6-bis(((2-hydroxy-1-naphthyl)methylene)amino-2H-benzimidazol-2-onato(2-)-N5,N6,O5,O6)nickel but also at least one additive, preferably in an amount of 0.01 to 80 parts by mass, particularly preferably in an amount of 0.05 to 50 parts by mass, very particularly preferably in an amount of 0.1 to 30 parts by mass, in each case based on 100 parts by mass of polyamide.

### Polyamides

Polyamides to be employed according to the invention may be produced by different processes and also synthesized from different units. A multitude of procedures for preparing polyamides has become known, it being possible to use, depending on the desired end product, different monomer units and various chain transfer agents to establish a desired molecular weight or else monomers with reactive groups for aftertreatments intended at a later stage.

The processes of industrial relevance for the preparation of polyamides usually proceed via polycondensation in the melt. In this context, the hydrolytic polymerization of lactams is also considered to be polycondensation.

Useful reactants include aliphatic and/or aromatic dicarboxylic acids, such as adipic acid, 2,2,4- and 2,4,4-trimethyladipic acid, azelaic acid, sebacic acid, isophthalic acid, terephthalic acid, aliphatic and/or aromatic diamines, for example tetramethylenediamine, hexamethylenediamine, nonane-1,9-diamine, 2,2,4- and 2,4,4-trimethylhexamethylenediamine, the isomeric diaminodicydohexylmethanes, diaminodicyclohexylpropanes, bisaminomethylcyclohexane, phenylenediamines, xylylenediamine, aminocarboxylic acids, for example aminocaproic acid, or the corresponding lactams. Particular preference is given to using caprolactams, especially ε-caprolactam. Copolyamides of a plurality of the monomers mentioned are included.

Preferred polyamides are semicrystalline polyamides that are preparable proceeding from diamines and dicarboxylic acids and/or lactams having at least 5 ring members or corresponding amino acids.

As particularly preferred polyamides are nylon-6, nylon-6,6, nylon-4,6 and/or semiaromatic copolyamides. Preferred semiaromatic copolyamides are PA6T/6, PA6T/66, PA6T/6I or PA6T/6I/66.

Polyamides for a particularly preferred according to the invention include polyamide 6 (PA6) [CAS No. 25038-54-4] and polyamide 66 (PA66) [CAS No. 25038-54-4], wherein polyamide 6 is especially particularly preferred.

The nomenclature of the polyamides used in the context of the present application corresponds to international standard ISO 1874-1, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA6.

The PA6 [CAS No. 25038-54-4] preferably employable according to the invention preferably has a viscosity number determinable according to ISO 307 in a 0.5% by weight solution in 96% by weight sulfuric acid at 25 °C in the range from 80 to 180 ml/g, particularly preferably in the range from 85 to 160 m/g and very particularly preferably in the range from 90 to 140 ml/g. Polyamide 6 employable according to the invention as component A) is available for example as Durethan® B26 from Lanxess Deutschland GmbH, Cologne.

The polyamide 66 [CAS No. 32131-17-2] preferably employable according to the invention preferably has a viscosity number determinable according to ISO 307 in a 0.5% by weight solution in 96% by weight sulfuric acid at 25 °C in the range from 80 to 180 ml/g, very particularly preferably a viscosity number in the range from 85 to 160 m/g, especially preferably in the range from 90 to 140 ml/g. Polyamide 66 employable according to the invention is obtainable for example as Ultramid® A24E01 from BASF SE, Ludwigshafen.

Polyamide employable according to the invention may also be used in admixture with at least one other polyamide and/or at least one other polymer. Preferred other polymers are selected from the group of polyethylene, polypropylene and acrylonitrile-butadiene-styrene copolymer (ABS). In the case of use of at least one further polyamide or at least one other polymer, this is preferably or optionally combined with use of at least one compatibilizer.

The polyamide employable according to the invention may be admixed with customary additives, preferably demoulding agents, stabilizers and/or flow auxiliaries known to those skilled in the art, already in the melt.

It is especially preferable in the context of the present invention to employ Durethan® B30S, from Lanxess Deutschland GmbH, Cologne, Germany as polyamide 6.

### 1,3-dihydro-5,6-bis(((2-hydroxy-1-naphthyl)methylene)amino-2H-benzimidazol-2-onato(2-)-N5,N6,O5,O6)nickel

According to the invention the orange pigment employed is the 1,3-dihydro-5,6-bis(((2-hydroxy-1-naphthyl)methylene)amino-2H-benzimidazol-2-onato(2-)-N5,N6,O5,O6)nickel known from DE OS 2263235. 1,3-dihydro-5,6-bis(((2-hydroxy-1-naphthyl)methylene)amino-2H-benzimidazol-2-onato(2-)-N5,N6,O5,O6)nickel may either be produced by one of the two processes in example 2 of DE OS 2263235 or is available as Pigment Orange 68 [CAS No. 42844-43-9] inter alia from Sinoever International, Dalian, China. For Pigment Orange 68 or 1,3-dihydro-5,6-bis(((2-hydroxy-1-naphthyl)methylene)amino-2H-benzimidazol-2-onato(2-)-N5,N6,O5,O6)nickel [CAS No. 42844-93-9] Sinoever International specifies the colour locus having the Cartesian coordinates L*=53.5 a*=58.2 and b*=76.7.

The 1,3-dihydro-5,6-bis(((2-hydroxy-1-naphthyl)methylene)amino-2H-benzimidazol-2-onato(2-)-N5,N6,O5,O6)nickel may be employed directly as a powder or else in the form of a masterbatch, in the form of a compact or in the form of a concentrate, wherein masterbatches are preferred and masterbatches in a polyamide matrix are particularly preferred.

1,3-Dihydro-5,6-bis(((2-hydroxy-1-naphthyl)methylene)amino-2H-benzimidazol-2-onato(2-)-N5,N6,O5,O6)nickel may be described as an adduct. An adduct in the context of the present invention is an assembled molecule wherein the bond between the metal—here nickel—and the rest of the molecule is preferably effected through intermolecular interactions, through Lewis acid-based interactions or through coordinative bonds. The term “adduct” in the context of the present invention is intended generally to encompass all types of intercalation and addition compounds. The terms “intercalation compound” or “addition compound” in the context of the present invention are preferably compounds that are formed by virtue of intermolecular interactions such as van der Waals interactions or Lewis acid-base interactions. The manner in which the intercalation proceeds in this case depends not only on the chemical properties of the component to be intercalated but also on the chemical nature of the host lattice. Such compounds are often also referred to as intercalation compounds. In the chemical sense, this refers to the incorporation of molecules, ions—occasionally even atoms—into chemical compounds.

Furthermore, the terms “intercalation compound” or “addition compound” are to be understood as also encompassing so-called clathrates. These are compounds of two substances, one of which is a guest molecule intercalated into a lattice or cage composed of a host molecule.

The terms “intercalation compound” or “addition compound” in the context of the present invention are to be understood as also encompassing mixed intercalation crystals and interstitial compounds. These are chemical, non-stoichiometric, crystalline compounds formed of at least two elements.

In addition, the terms “intercalation compound” or “addition compound” in the context of the present invention shall also be understood as encompassing compounds which are formed on the basis of coordinate bonds or complex bonds. Such compounds are in some cases also referred to as mixed substitution crystals or mixed replacement crystals in which at least two substances form a common crystal and the atoms of the second component are located at regular lattice sites of the first component.

### Further Components

In a preferred embodiment at least one filler or reinforcer is employed. It is also possible to employ mixtures of two or more different fillers and/or reinforcers.

It is preferable to employ at least one filler or reinforcer from the group of carbon fibres [CAS No. 7440-44-0], glass beads or solid or hollow glass beads, or glass fibres, or milled glass, amorphous quartz glass, aluminium borosilicate glass having an alkali content of 1% (E glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or milled quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of formula AIO(OH), magnesium carbonate [CAS No. 12125-28-9], titanium dioxide [CAS No. 13463-67-7] and talc [CAS No. 14807-96-6].

It is preferable to employ Pigment Orange 68 in combination with titanium dioxide. It is preferable to employ 1 to 150 parts by mass, particularly preferably 5 to 80 parts by mass, very particularly preferably 10 to 50 parts by mass, of titanium dioxide.

Titanium dioxide 13463-67-7 (TiO₂) employable according to the invention, the use of which particularly helps the effects according to the invention to manifest, encompasses the crystal form thereof having CAS No. 1317-70-0 (anatase), having CAS No. 12188-41-9 (brookite) or CAS No. 1317-80-2 (rutile).

Particularly preferred fibrous fillers or reinforcers include glass fibres and wollastonite, wherein glass fibres are very particularly preferred. According to “http://de.wikipedia.orghwiki/Faser-Kunststoff-Verbund”, in terms of the glass fibres a person skilled in the art distinguishes between chopped fibres, also called short fibres, having a length in the range from 0.1 to 1 mm, long fibres having a length in the range from 1 to 50 mm, and continuous fibres having a length L>50 mm. Short fibres are preferably employed in injection moulding technology and may be directly processed with an extruder. Long fibres can likewise still be processed in extruders.

Said fibres are widely used in fibre spraying. Long fibres are frequently added to thermosets as a filler. Continuous fibres are used in the form of rovings or weaves in fibre-reinforced plastics. Articles of manufacture comprising continuous fibres achieve the highest stiffness and strength values. Also available are ground glass fibres, the length of which after grinding is typically in the range from 70 to 200 μm.

Glass fibres preferably employable as fillers or reinforcers according to the invention include chopped long glass fibres having an average starting length determinable by laser diffraction particle size analysis (laser granulometry/laser diffractometry) according to ISO 13320 in the range from 1 to 50 mm, particularly preferably in the range from 1 to 10 mm, very particularly preferably in the range from 2 to 7 mm. For laser diffraction particle size determination/laser diffractometry according to the standard ISO 13320, see:
https://de.wikipedia.org/wiki/Laserbeugungs-Partikelgr%C3%B6%C3%9Fenanalyse

Preferred glass fibres employable as fillers or reinforcers have an average fibre diameter determinable by laser diffractometry according to ISO 13320 in the range from 7 to 18 μm, particularly preferably in the range from 9 to 15 μm.

In a preferred embodiment, the glass fibres preferably employable as fillers or reinforcers are preferably modified with a suitable size system or an adhesion promoter/adhesion promoter system. Preference is given to using a size system or a silane-based adhesion promoter.

### Flame Retardants

In a preferred embodiment at least one flame retardant is employed. Preferred flame retardants are mineral flame retardants, nitrogen-containing flame retardants or phosphorus-containing flame retardants.

Among the mineral flame retardants, magnesium hydroxide is particularly preferred. Magnesium hydroxide [CAS No. 1309-42-8] may be impure as a result of its origin and mode of production. Typical impurities include, for example, silicon-, iron-, calcium- and/or aluminium-containing species which may be intercalated, for example, in the form of oxides in the magnesium hydroxide crystals. The magnesium hydroxide employable as a mineral flame retardant may be unsized or else sized. The magnesium hydroxide employable as a mineral flame retardant is preferably provided with sizes based on stearates or aminosiloxanes, particularly preferably with aminosiloxanes. Magnesium hydroxide preferably employable as a mineral flame retardant has an average particle size d50 determinable by laser diffractometry according to ISO 13320 in the range from 0.5 μm to 6 μm, preference being given to a d50 in the range from 0.7 μm to 3.8 μm and particular preference being given to a d50 in the range from 1.0 μm to 2.6 μm.

Magnesium hydroxide types suitable as a mineral flame retardant according to the invention include for example Magnifin® H5IV from Martinswerk GmbH, Bergheim, Germany or Hidromag® Q2015 TC from Penoles, Mexico City, Mexico.

Preferred nitrogen-containing flame retardants include the reaction products of trichlorotriazine, piperazine and morpholine of CAS No. 1078142-02-5, in particular MCA PPM Triazine HF from MCA Technologies GmbH, Biel-Benken, Switzerland, and also melamine cyanurate and condensation products of melamine, in particular melem, melam, melon or more highly condensed compounds of this type. Preferred inorganic nitrogen-containing compounds are ammonium salts.

In addition, it is also possible to use salts of aliphatic and aromatic sulfonic acids and mineral flame retardant additives, especially aluminium hydroxide or Ca-Mg carbonate hydrates (DE-A 4236122).

However, in an alternative embodiment, zinc-containing compounds may also be employed. These preferably include zinc oxide, zinc borate, zinc stannate, zinc hydroxystannate, zinc sulfide and zinc nitride, or mixtures thereof.

Preferred phosphorus-containing flame retardants are organic metal phosphinates, aluminium salts of phosphonic acid, red phosphorus, inorganic metal hypophosphites, metal phosphonates, derivatives of 9,10-dihydro-9-oxa-10-phosphaphenanthrene-10-oxides (DOPO derivatives), resorcinol bis(diphenyl phosphate) (RDP) including oligomers, bisphenol A bis(diphenyl phosphate) (BDP) including oligomers, melamine pyrophosphate, melamine polyphosphate, melamine poly(aluminium phosphate), melamine poly(zinc phosphate) or phenoxyphosphazene oligomers and mixtures thereof.

A preferred organic metal phosphinate is aluminium tris(diethylphosphinate). A preferred inorganic metal hypophosphite is aluminium hypophosphite.

Further employable flame retardants include char formers, particularly preferably phenol-formaldehyde resins, polycarbonates, polyimides, polysulfones, polyether sulfones or polyether ketones, and also antidrip agents, in particular tetrafluoroethylene polymers.

Halogen-containing flame retardants may also be employed. Preferred halogen-containing flame retardants are commercially available organic halogen compounds, more preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide, wherein among the halogenated flame retardants brominated polystyrene is particularly preferred. Brominated polystyrene is used here preferably in amounts in the range from 10% to 30% by weight, particularly preferably in amounts in the range from 15% to 25% by weight, based in each case on the overall composition, where at least one of the other components is reduced to such an extent that the sum total of all weight percentages is always 100.

Brominated polystyrene is commercially available in a wide variety of product qualities. Examples thereof are for example Firemaster® PBS64 from Lanxess, Cologne, Germany and Saytex® HP-3010 from Albemarle, Baton Rouge, USA.

### Additives

In a preferred embodiment at least one additive is employed in addition to the polyamide and 1,3-dihydro-5,6-bis(((2-hydroxy-1-naphthyl)methylene)amino-2H-benzimidazol-2-onato(2-)-N5,N6,O5,O6)nickel. Preferably employable additives include antioxidants, thermal stabilizers, UV stabilizers, gamma ray stabilizers, components for reducing water absorption or hydrolysis stabilizers, antistats, emulsifiers, nucleating agents, plasticizers, processing auxiliaries, impact modifiers, lubricants and/or demoulding agents, components for reducing water absorption, flow auxiliaries or elastomer modifiers, chain-extending additives and colourants distinct from 1,3-dihydro-5,6-bis(((2-hydroxy-1-naphthyl)methylene)amino-2H-benzimidazol-2-onato(2-)-N5,N6,O5,O6)nickel. The additives may be employed alone or in admixture or in the form of masterbatches.

Preferable heat stabilizers as additives include sterically hindered phenols, in particular those containing at least one 2,6-di-tert-butylphenyl- and/or 2-tert-butyl-6-methylphenyl group, and also phosphites, hypophosphites, especially sodium hypophosphite NaH₂PO₂, hydroquinones, aromatic secondary amines, substituted resorcinols, salicylates, benzotriazoles and benzophenones, 3,3′-thiodipropionic esters and variously substituted representatives of these groups or mixtures thereof. The heat stabilizers employable as additives are preferably employed in amounts of 0.01 to 2 parts by mass, particularly preferably 0.05 to 1 parts by mass, in each case based on 100 parts by mass of polyesters.

UV stabilizers employable as additives preferably include substituted resorcinols, salicylates, benzotriazoles and benzophenones, HALS derivatives (“Hindered Amine Light Stabilizers”) containing at least one 2,2,6,6-tetramethyl-4-piperidyl unit or benzophenones. The UV stabilizers employable as additives are preferably employed in amounts of 0.01 to 2 parts by mass, particularly preferably 0.1 to 1 parts by mass, in each case based on 100 parts by mass of polyesters.

Colourants employable as additives and distinct from 1,3-dihydro-5,6-bis(((2-hydroxy-1-naphthyl)methylene)amino-2H-benzimidazol-2-onato(2-)-N5,N6,O5,O6)nickel preferably include inorganic pigments, in particular ultramarine blue, bismuth vanadate, iron oxide, titanium dioxide, zinc sulfide, zinc-titanium-zinc oxides [CAS No. 923954-49-8] and also organic dyes, preferably phthalocyanines, quinacridones, benzimidazoles, in particular pyrimidine-azo-benzimidazole [CAS No. 72102-84-2] and/or Pigment Yellow 192 [CAS No. 56279-27-7] as well as perylenes, anthraquinones, in particular C.I. Solvent Yellow 163 [CAS No. 13676-91-0] perinones, in particular 10,10′-Oxy-bis-12H-phthaloperin-12-one [CAS No. 203576-97-0], this enumeration being nonexhaustive. In one embodiment, carbon black or nigrosine are also employed as colourants.

Nucleating agents employable as additives preferably include sodium or calcium phenylphosphinate, aluminium oxide or silicon dioxide and very particularly preferably talc, this enumeration being nonexhaustive.

Plasticizers preferably employable as additives include dioctyl phthalate, dibenzyl phthalate, butyl benzyl phthalate, hydrocarbon oils or N-(n-butyl)benzenesulfonamide.

Elastomer modifiers preferably employable as additives comprise inter alia one or more graft polymers of
E.1 5% to 95% by weight, preferably 30% to 90% by weight, of at least one vinyl monomer and
E.2 95% to 5% by weight, preferably 70% to 10% by weight, of one or more graft substrates having glass transition temperatures <10 °C, preferably <0 °C, particularly preferably <−20 °C, where the percentages by weight are based on 100% by weight of elastomer modifier. The graft substrate E.2 generally has an average particle size d50 value determinable by laser diffractometry according to ISO 13320 of 0.05 to 10 μm, preferably 0.1 to 5 μm, particularly preferably 0.2 to 1 μm.

Monomers E.1 are preferably mixtures of
E.1.1 50% to 99% by weight of vinylaromatics and/or ring-substituted vinylaromatics, especially styrene, α-methylstyrene, p-methylstyrene, p-chlorostyrene, and/or (C₁-C₈)-alkyl methacrylates, especially methyl methacrylate, ethyl methacrylate and
E.1.2 1% to 50% by weight of vinyl cyanides, especially unsaturated nitriles such as acrylonitrile and methacrylonitrile and/or (C₁-C₈)-alkyl (meth)acrylates, especially methyl methacrylate, glycidyl methacrylate, n-butyl acrylate, t-butyl acrylate, and/or derivatives, especially anhydrides and imides of unsaturated carboxylic acids, especially maleic anhydride or N-phenylmaleimide, where the percentages by weight are based on 100% by weight of elastomer modifier.

Preferred monomers E.1.1 are to be selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft substrates E.2 suitable for the graft polymers employable in the elastomer modifiers include, for example, diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft substrates E.2 are diene rubbers, in particular based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of component E.2 is <10 °C, preferably <0 °C, particularly preferably <−10 °C.

Lubricants and/or demoulding agents employable as additives preferably include long-chain fatty acids, especially stearic acid or behenic acid, salts thereof, especially calcium stearate or zinc stearate, and the ester derivatives thereof, especially those based on pentaerythritol, especially fatty acid esters of pentaerythritol or amide derivatives, especially ethylenebisstearylamide, montan waxes and low molecular weight polyethylene or polypropylene waxes. Montan waxes in the context of the present invention are mixtures of straight-chain saturated carboxylic acids having chain lengths of 28 to 32 carbon atoms.

### Process

The invention also relates to a process for producing tracking-resistant electromobility components having a colour distance ΔE from the L*a*b* coordinates to a colour number of the RAL colour chart beginning with a “2” of <20 and having a CTI determinable according to IEC 60112 in the range from 525 to 600 volts with a maximum divergence in the CTI of 2.5% relative to a component of the same composition without colourant by mixing at least one polyamide and 1,3-dihydro-5,6-bis(((2-hydroxy-1-naphthyl)methylene)amino-2H-benzimidazol-2-onato(2-)-N5,N6,O5,O6)nickel to afford polymer compositions, extruding said mixtures, cooling them until pelletizable, drying and pelletizing them and subsequently further processing the polymer compositions by injection moulding, including the special processes of gas injection techniques (GIT), water injection techniques (WIT) or projectile injection techniques (PIT), in extrusion processes, including in profile extrusion or by blow moulding, wherein
A) per 100 parts by mass of at least one polyamide,
B) 0.01 to 5 parts by mass of 1,3-dihydro-5,6-bis(((2-hydroxy-1-naphthyl)methylene)amino-2H-benzimidazol-2-onato(2-)-N5,N6,O5,O6)nickel are employed.

It is preferable when also for the process according to the invention the electromobility components have a colour distance ΔE from the L*a*b* coordinates to a colour number of the RAL colour chart beginning with a “2” of <10, particularly preferably <5.

It is preferable to employ polyamide 6 or polyamide 66, in particular polyamide 6.

The invention particularly preferably relates to a process for producing tracking-resistant electromobility components having a colour distance ΔE from the L*a*b* coordinates to a colour number of the RAL colour chart beginning with a “2” of <20 and having a CTI determinable according to IEC 60112 in the range from 525 to 600 volts with a maximum divergence in the CTI of 2.5% relative to a component of the same composition without colourant by mixing at least one polyamide and 1,3-dihydro-5,6-bis(((2-hydroxy-1-naphthyl)methylene)amino-2H-benzimidazol-2-onato(2-)-N5,N6,O5,O6)nickel to afford polymer compositions, extruding said mixtures, cooling them until pelletizable, drying and pelletizing them and subsequently further processing the polymer compositions by injection moulding, including the special processes of gas injection techniques (GIT), water injection techniques (WIT) or projectile injection techniques (PIT), in extrusion processes, including in profile extrusion or by blow moulding, wherein
A) per 100 parts by mass of at least one polyamide,
B) 0.01 to 5 parts by mass of 1,3-dihydro-5,6-bis(((2-hydroxy-1-naphthyl)methylene)amino-2H-benzimidazol-2-onato(2-)-N5,N6,O5,O6)nickel and
C) 1 to 150 parts by mass, particularly preferably 5 to 80 parts by mass, very particularly preferably 10 to 50 parts by mass, of titanium dioxide are employed.

For the sake of clarity, it is noted that the scope of the present invention encompasses all definitions and parameters recited in general in the context of the electromobility components or recited in ranges of preference in any desired combinations of the processes according to the invention.

### EXAMPLES

To demonstrate the improvements in properties described in accordance with the invention, corresponding polyamide-based polymer compositions were first made up by compounding. To this end, the individual components were mixed in a twin-screw extruder (Leistritz LSM 30-34 from Leistritz AG (Nuremberg, Germany)) at temperatures between 270 °C to 300 °C, extruded, cooled until pelletizable and pelletized. After drying (generally for two days at 80 °C in a vacuum drying cabinet), the pellets were processed by injection moulding at temperatures in the range from 270 to 290 °C to give standard test specimens for the respective tests.

In the context of the present invention the measure for tracking resistance of the moulding materials described in table I in the form of 60·40·2 mm³ plates was the CTI value (comparative tracking index) in volts according to IEC 60112.

### Starting Materials:

Component A) nylon-6 (Durethan® B30S, from Lanxess Deutschland GmbH, Cologne, Germany)
Component B): 1,3-dihydro-5,6-bis(((2-hydroxy-1-naphthyl)methylene)amino-2H-benzimidazol-2-onato(2-)-N5,N6,O5,O6)nickel [CAS-No. 42844-93-9], Lanxess Deutschland GmbH, Cologne, Germany)
Component C): Neolor Light Orange H (Pigment Orange 78, CAS-No. 12014-93-6, ColorChem International Corp., Atlanta, USA)
Component D): Titanium dioxide (R-FK-3, Tronox, Stamford, USA)

TABLE I

| | | Ex. 1 | Comp. 1 | Ex. 2 | Comp. 2 |
|---|---|---|---|---|---|
| Component A) | Pts. by wt. | 99.9 | 100 | 99.4 | 99.4 |
| Component B) | Pts. by wt. | 0.1 | | 0.3 | |
| Component C) | Pts. by wt. | | | | 0.3 |
| Component D) | Pts. by wt. | | | 0.3 | 0.3 |
| CTI tracking resistance | [V] | 598 | 600 | 575 | 550 |

The results in table I the inventive example 1 shows no adverse impairment of the tracking resistance determined according to IEC 60112 compared to the uncoloured material in comp. 1. If in terms of tracking resistance EP 3 868 817 Alis considered the closest prior art, inventive example 2 surprisingly shows that 1,3-dihydro-5,6-bis(((2-hydroxy-1-naphthyl)methylene)amino-2H-benzimidazol-2-onato(2-)-N5,N6,O5,O6)nickel achieved a 5% increase in tracking resistance compared to comp. 2 (which employed Pigment Orange 78). The plastic sheets examined in inventive examples 1 and 2 had an RAL colour value of 2001 with a ΔE of <10.

The tracking resistance of the samples investigated in the context of the present application was then determined in accordance with IEC 60112 “Method for the determination of the proof and the comparative tracking indices of solid insulating materials” using 60 mm·60 mm·2 mm plates by applying altogether 50 droplets of standardized electrolyte solution dropwise at a time interval of 30 seconds and simultaneously measuring the current between two platinum electrodes on the surface until a tracking current of >0.5 A was achieved.

1. A tracking-resistant electromobility component having a colour distance ΔE from the L*a*b* coordinates to a colour number of the RAL colour chart beginning with a “2” of <20 comprising at least one polyamide and 1,3-dihydro-5,6-bis(((2-hydroxy-1-naphthyl)methylene)amino-2H-benzimidazol-2-onato(2-)-N5,N6,O5,O6)nickel, wherein the tracking-resistant electromobility component has a CTI determinable according to IEC 60112 in the range from 525 to 600 volts with a maximum divergence in the CTI of 2.5% relative to a component of the same composition without colourant.

2. The tracking-resistant electromobility component according to claim 1, wherein the at least one polyamide is polyamide 6 or polyamide 66.

3. The tracking resistant electromobility component according to claim 1, wherein 0.01 to 5 parts by mass of the 1,3-dihydro-5,6-bis(((2-hydroxy-1-naphthyl)methylene)amino-2H-benzimidazol-2-onato(2-)-N5,N6,O5,O6)nickel are present per 100 parts by mass of the at least one polyamide.

4. The tracking resistant electromobility component according to claim 1, wherein the 1,3-dihydro-5,6-bis(((2-hydroxy-1-naphthyl)methylene)amino-2H-benzimidazol-2-onato(2-)-N5,N6,O5,O6)nickel is employed in combination with titanium dioxide.

5. The tracking resistant electromobility component according to claim 1, wherein the tracking-resistant electromobility component is either directly in contact with a voltage-conducting part, or is directly adjacent thereto, or is in spatial proximity thereto, and acts as a touch guard, a warning marking, or a shielding means.

6.-15. (canceled)

16. The tracking-resistant electromobility component according to claim 3, wherein 0.01 to 3 parts by mass of the 1,3-dihydro-5,6-bis(((2-hydroxy-1-naphthyl)methylene)amino-2H-benzimidazol-2-onato(2-)-N5,N6,O5,O6)nickel are present per 100 parts by mass of the at least one polyamide.

17. The tracking-resistant electromobility component according to claim 4, wherein 1 to 150 parts by mass of the titanium dioxide are present per 100 parts by mass of the at least one polyamide.

18. The tracking-resistant electromobility component according to claim 17, wherein 5 to 80 parts by mass of the titanium dioxide are present per 100 parts by mass of the at least one polyamide.

19. The tracking-resistant electromobility component according to claim 18, wherein 10 to 50 parts by mass of the titanium dioxide are present per 100 parts by mass of the at least one polyamide.

20. The tracking-resistant electromobility component according to claim 1,
wherein,
in the case of a battery component, said electromobility component is selected from standard and round cell modules, cell housings, cell connectors, cell contacting systems, module connectors, pressure compensating elements, seals and intelligent battery management systems, or,
in the case of a proton-exchange membrane fuel cell, said electromobility component is selected from modules or stack modules, metallic bipolar plates, end and media modules and sealing systems, or,
in the case of an electric drive unit, said electromobility component is selected from seals and function-integrated housing lids, housing seals, shaft sealing rings, disk carriers and stamped stacks, shielding systems and dynamic precision parts.

21. A process for producing a tracking-resistant polyamide-based electromobility component having a colour distance ΔE from the L*a*b* coordinates to a colour number of the RAL colour chart beginning with a “2” of <20 comprising
mixing 1,3-dihydro-5,6-bis(((2-hydroxy-1-naphthyl)methylene)amino-2H-benzimidazol-2-onato(2-)-N5,N6,O5,O6)nickel with at least one polyamide;
extruding the mixture;
cooling the extruded mixture until pelletizable;
pelletizing; and
injection molding or extruding the pellets into an electromobility component,
wherein tracking resistance of the electromobility component in the form of a CTI determinable according to IEC 60112 is in the range from 525 to 600 volts with a maximum divergence in the CTI of 2.5% relative to a component of the same composition without colourant.

22. The process according to claim 21, wherein the at least one polyamide is polyamide 6 or polyamide 66.

23. The process according to claim 21, wherein 0.01 to 5 parts by mass of the 1,3-dihydro-5,6-bis(((2-hydroxy-1-naphthyl)methylene)amino-2H-benzimidazol-2-onato(2-)-N5,N6,O5,O6)nickel are present per 100 parts by mass of the at least one polyamide.

24. The process according to claim 21, wherein the 1,3-dihydro-5,6-bis(((2-hydroxy-1-naphthyl)methylene)amino-2H-benzimidazol-2-onato(2-)-N5,N6,O5,O6)nickel is employed in combination with titanium dioxide.

25. The process according to claim 24, wherein 1 to 150 parts by mass of the titanium dioxide are present per 100 parts by mass of the at least one polyamide.

26. The process according to claim 24, wherein 5 to 80 parts by mass of the titanium dioxide are present per 100 parts by mass of the at least one polyamide.

27. The process according to claim 24, wherein 10 to 50 parts by mass of the titanium dioxide are present per 100 parts by mass of the at least one polyamide.

28. The process according to claim 21, wherein the electromobility component is a component that is either directly in contact with a voltage-conducting part, or directly adjacent to a voltage-conducting part, or in spatial proximity to a voltage-conducting part and acts as a touch guard, a warning marking or a shielding means.

29. The process according to claim 21, wherein the injection molding includes gas injection techniques, water injection techniques or projectile injection techniques.

30. The process according to claim 21, wherein the extruding includes profile extrusion or blow moulding.
